(19) United States
(12) Patent Application Publication
(10) Pub. No.: US 2007/0112637 A1
(43) Pub. Date: May 17, 2007

(54) Interactive peer validation for product choices

(75) Inventor: Tina Koon-Meng So, Cincinnati, OH (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(73) Assignee: The Procter & Gamble Company

(21) Appl. No.: 11/598,345

(22) Filed: Nov. 13, 2006

Related U.S. Application Data
(60) Provisional application No. 60/736,338, filed on Nov. 14, 2005.

(51) Int. Cl. G06Q 30/00

(52) U.S. Cl. 705/26

(57) ABSTRACT

A method of facilitating purchasing decisions, the method comprising: providing a survey such as an online questionnaire comprising a plurality of questions; providing as choices in the survey a limited set of products from one manufacturer to be surveyed among a predetermined set of consumer peers; urging users to complete the questions by selecting among choices of the products; facilitating submission of the survey; receiving the survey results; and suggesting purchase decisions based on validation by the peers of the product choices.

### CROSS REFERENCE TO RELATED APPLICATION

This application claims the benefit of U.S. Provisional Application No. 60/736,338, filed Nov. 14, 2005.

### FIELD OF THE INVENTION

The invention is directed to a method for using internet surveys to interactively validate product choices for targeted users of products.

### BACKGROUND OF INVENTION

Product users often wish to know how and what other users of products are purchasing. Often the purchase decision is based not only on the actual performance characteristics of the product, but also on the perception that others are using the product. In some cases the primary purchase decision may be driven by the perception that others whom a user respects or wishes to immolate are using certain products.

Accordingly, there remains a need for a method for purchasers to determine how their peers are purchasing and using products.

Further, it would be desirable to have an easily accessible, interactive platform for users of products to contribute to the results as well as access the results of a user survey that shows what peers prefer.

Further, it would be desirable to have a method in which a targeted segment of the population could utilize interactive tools on the internet to seek validation for purchasing decisions.

### BRIEF DESCRIPTION OF THE DRAWINGS

FIGS. 1-3 are screen shots of an exemplary web-based embodiment of the present invention.

### DETAILED DESCRIPTION OF THE INVENTION

The method of the present invention is directed to interactive, internet-based surveys for the purpose of providing peer-to-peer validation of consumer purchase choices. In one embodiment, the method is used to provide validation for a predetermined, defined segment of the consumer population. In one embodiment the defined segment is teenage girls.

In one embodiment, the invention is computer program designed to be a platform for teenaged girls to provide peer to peer endorsement of specific products, such as products manufactured and sold by a specific manufacturer. By building such a platform, the method of the present invention can utilize the power of the teen social network and encourage the purchase of a specific manufacturer's products. Also, because certain segments of a purchasing population, such as teenage girls, seek validation from their peers regarding the products they use, providing the type of exchange embodied in the present invention, a community aspect of the population segment is enhanced. Unlike other programs, the method of the present invention takes advantage of peer influencers to generate peer-to-peer product recommendations.

The method of the present invention also helps build the business of a product manufacturer by generating sales preferences among a predetermined segment of a consumer population. In one embodiment, the method of the present invention generates an award for a peer-evaluated winning product. The award can be, for example, a “stamp of approval” with an appropriate logo or other identifying indicia. The award can be added to the product's label, advertising, website, or other marketing tools. In this manner, the peer-inputted choice data can be utilized to drive further sales of a given product. Further, the “stamp of approval” logo or identifier can be used in a web-based system to link back to the originating website to further drive web traffic and internet marketing.

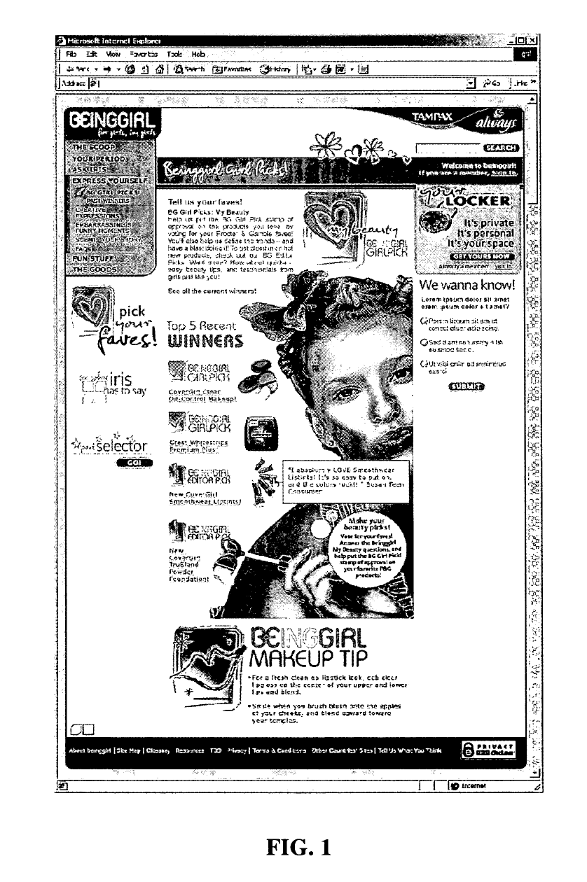

In one embodiment, teenage girls can vote for their favorite products, such as their favorite products from The Procter & Gamble Company, on an on-line survey located on a survey website, as shown in FIG. 1. As shown in FIG. 1, the website can be directed to a narrow segment of a population of consumers, such as teenage girls. The website shown is that of www.beinggirl.com. The survey can be open for a predetermined amount of time, for example, for one or two weeks. To promote the survey, a prominently placed banner calling out the survey under a predetermined name can be placed on the website. The banner calling out the survey serves to urge users to complete the survey. In the illustrated embodiment shown in FIG. 1, the survey name is “Beinggirl Girl Picks” which can be identified as “girlpicks” in some embodiments.

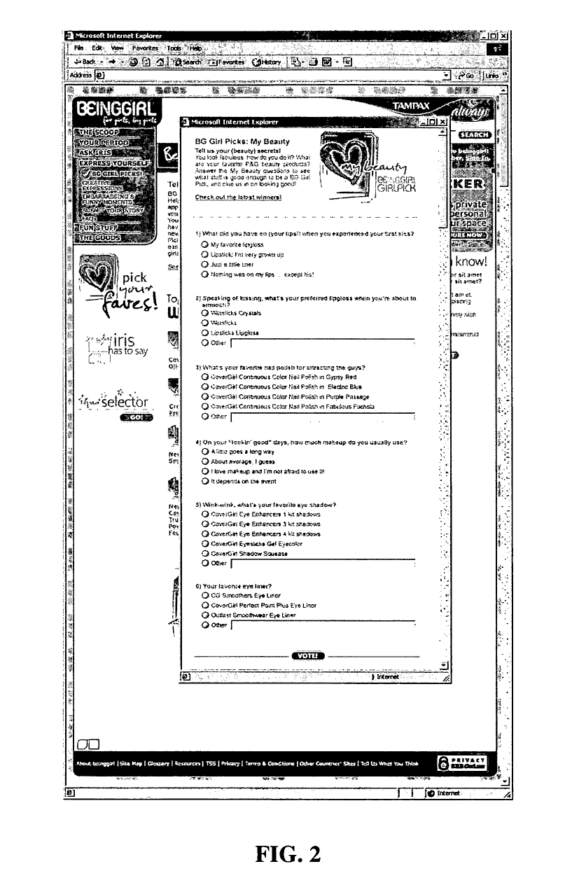

Selecting a predetermined menu selection, such as the “Express yourself” “BG Girl Picks” menu items in FIG. 1 can take the user to a survey page, as shown in FIG. 2. The survey can be limited to a certain category of products, such as “beauty” as shown in FIG. 2. Other categories can include “body” and “being.” The categories can limit the range of products surveyed. For example, in the “beauty” category, product choices can include cosmetics and hair care product. In the “body” category, products can include deodorants, soaps, and perfumes. In the “being” category products can include feminine hygiene products such as sanitary napkins and tampons.

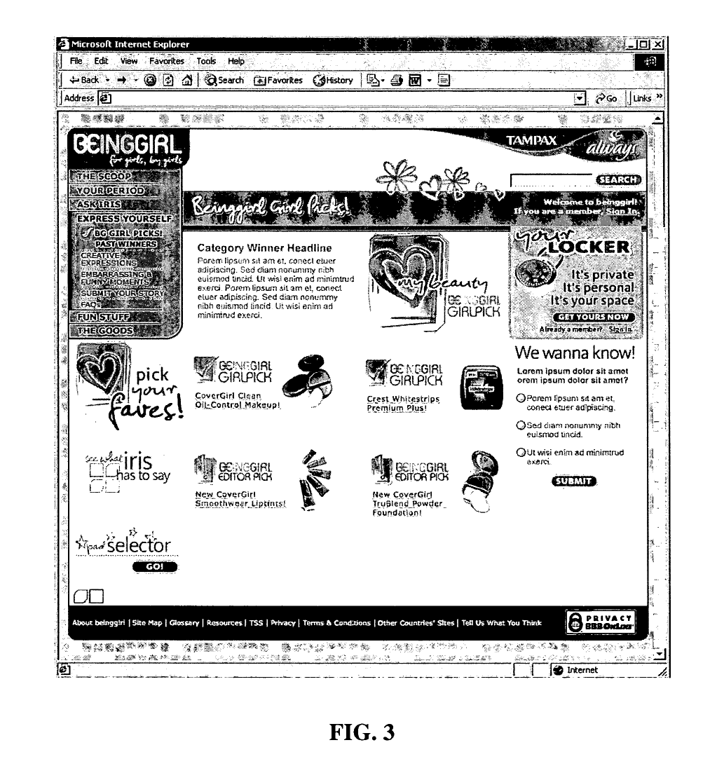

Survey questions can be answered by clicking on “radio buttons” as shown in FIG. 2. The survey can be opened in a new window as shown. Once the survey is completed the results can be announced on a page with a category winner headline as shown in FIG. 3.

In one embodiment, surveys are conducted by time of year. For example, the “beauty” category can run under the nomenclature “My Beauty” for fall/winter. The “body” category can run under the nomenclature “My body” in Spring. The “being” category can be run under the nomenclature “My being” in Summer.

### EXAMPLE

The following is an example of the content of an embodiment of the present invention which correlates to the FIGS. 1-3. This example is illustrative of one embodiment of the invention involving the consumer segment of teenage girls and products from The Procter & Gamble Co.

[Global Navigation]

The Scoop [links to ]
Your Period [links to ]
Ask Iris [links to ]
Express Yourself [links to ]

BG Girl Picks [links to EX7]
Creative Expressions [links to ]
Laugh Out Loud [links to ]
Girl Talk [links to EX6 new Girl Talk landing page]
Submit Your Story [links to ]
FAQ [links to ]
bgAdvisor [links to ]

Fun Stuff [links to ]
The Goods [links to ]

[new featured callout for Girl Picks program]

| | |
|---|---|
| [Subhead] | Pick your faves: BG Girl Picks! |
| [Content] | Your opinion counts at beinggirl, a LOT! So much that we |
| | created a totally cool award program where YOU decide the |
| | winners! Pick your favorite Procter & Gamble products and |
| | see which ones earn the BG Girl Pick! stamp of approval! |
| [button] | Pick your faves! [Launches survey or registration options |
| | in new window. If user is not a member, goes to RE join |
| | beinggirl page. If user is a member but not logged in, goes to |
| | LI log in page. If user is a member and is logged in, goes to |
| | the current survey.] |

EX7: Girl Picks landing page

| | |
|---|---|
| Title: | BG Girl Picks! |
| Keywords: | None |
| Description: | Tell us your favorite products and tips! |

[Global Navigation]

The Scoop [links to ]
Your Period [links to ]
Ask Iris [links to ]
Express Yourself [links to ]

BG Girl Picks [HIGHLIGHTED]

[Navigation note: current survey doesn't appear in

| | |
|---|---|
| navigation because | it launches in a popup |
| window] | |

Current Winners [links to EX7.1]
Past Winners [links to EX7.2]

Creative Expressions [links to ]
Laugh Out Loud [links to ]
Girl Talk [links to EX6 new Girl Talk landing page]
Submit Your Story [links to ]
FAQ [links to ]
bgAdvisor [links to ]

Fun Stuff [links to ]
The Goods [links to ]

[Center Column]

| | |
|---|---|
| [Header] | Tell us your faves! |
| [Subhead] | BG Girl Picks: My Beauty |
| [Content] | Help us put the BG Girl Pick stamp of approval on the |
| | products you love, by voting for your Procter & Gamble |
| | faves! You'll also help us define the trends - and have |
| | a blast doing it! To get clued in on hot new products, |
| | check out our BG Editor Picks. Want more? How about |
| | quick-n-easy beauty tips, and testimonials from girls |
| | just like you! |

[button or display text] See all the current winners! [links to EX7. 1]
[Sample text for BG Girl Picks, BG Editor's Picks, BG Beauty Tips and testimonials, as neededfor comp]
[show BG Girl Pick logo] CoverGirl Clean Oil-Control Makeup!
[show BG Girl Pick logo] Crest Whitestrips Premium Plus!
[show BG Editor's Pick logo] New CoverGirl Smoothwear Liptints!
[show BG Editor's Pick logo] New CoverGirl TruBlend Powder Foundation!
[Show BG Beauty Tip logo] For a fresh, clean, no-lipstick look, dab clear lip gloss on the center of your upper and lower lips and blend.
[Show BG Beauty Tip logo] Smile when you brush blush onto the apples of your cheeks, and blend upward toward your temples.
[Rollover text: sample testimonial] “I absolutely LOVE Smoothwear Liptints! It's so easy to put on, and the colors rock!!!” Susan Teen Consumer

[Current survey callout with My Beauty icon: [Launches survey or registration options in new window. If user is not a member, goes to RE join beinggirl page. If user is a member but not logged in, goes to LI log in page. If user is a member and is logged in, goes to the current survey.]

Vote for your faves now!

| | |
|---|---|
| [Survey | shows various places on beinggirl site. [Launches survey |
| callout: | or registration options in new window. If user is not a |
| | member, goes to RE join beinggirl page. If user is a member |
| | but not logged in, goes to LI log in page. If user is a |
| | member and is logged in, goes to the current survey.] |
| [Header] | Make your beauty picks! |
| [Content] | Vote for your faves! Answer the My Beauty questions, and |
| | help put the BG Girl Pick stamp of approval on your favorite |
| | P&G products! |

Active survey for BG Girl Picks program:
launches in new popup window

| | |
|---|---|
| Title: | Beinggirl Girl Picks!: My Beauty |
| Keywords: | None |
| Description: | You tell us the best beauty products! |

[Note: no navigation shows because current survey launches in a new popup window]

| | |
|---|---|
| [Header:] | BG Girl Picks: My Beauty |
| [Subhead] | Tell us your (beauty) secrets! |
| [Content] | You look fabulous; how do you do it? What are your |
| | favorite P&G beauty products? Answer the My Beauty |
| | questions to see what stuff is good enough to be a BG |
| | Girl Pick, and clue us in on looking good! |

[Button or display text] Check out the latest winners! [Links to EX7. I current winners page]
[Error message: displays if reader does not answer survey question(s) along with unanswered question(s) highlighted in red]
Ooops! Please select an answer for each question, and then click the “Vote” button again.
1) What did you have on (your lips!) when you experienced your first kiss?
[radio buttons]
My favorite lip gloss
Lipstick; I'm very grown up
Just a little liner
Nothing was on my lips ... except his!
2) Speaking of kissing, what's your preferred lip gloss when you're about to smooch?
[radio buttons]
Wetslicks Crystals
Wetslicks
Lipslicks Lip gloss
Other [field text box]
3) What's your favorite nail polish for attracting the guys?
[radio buttons]
CoverGirl Continuous Color Nail Polish in Gypsy Red
CoverGirl Continuous Color Nail Polish in Electric Blue
CoverGirl Continuous Color Nail Polish in Purple Passage
CoverGirl Continuous Color Nail Polish in Fabulous Fuchsia
Other [field text box]
4) On your “lookin'good” days, how much makeup do you usually use?
[radio buttons]
A little goes a long way
About average, I guess
I love makeup and I'm not afraid to use it!
It depends on the event
5) Wink-wink, what's your favorite eye shadow?
[radio buttons]
CoverGirl Eye Enhancers 1 kit shadows
CoverGirl Eye Enhancers 3 kit shadows
CoverGirl Eye Enhancers 4 kit shadows
CoverGirl Eyeslicks Gel Eyecolor
CoverGirl Shadow Squease
Other [field text box]
6) Your favorite eye liner?
[radio buttons]
CG Smoothers Eye Liner
CoverGirl Perfect Point Plus Eye Liner
Outlast Smoothwear Eye Liner
Other [field text box]
7) Then there's mascara; what's your fave?
[radio buttons]
CoverGirl Fantastic Lash Mascara
CoverGirl Multiplying Mascara
CoverGirl Fantastic Lash Waterproof Mascara
Other [field text box]
8) Perfecting your technique can be tricky. Who is teaching you how to apply makeup?
[radio buttons]
My mom helps me
I'm learning from my girlfriends
Older female relatives and friends
No one; I'm “making it up” as I go along!
9) Let's get back to the basics. What's your favorite foundation makeup?
[radio buttons]
CoverGirl Clean Pressed Powder
CoverGirl Clean Makeup
CoverGirl Clean Oil-Control Makeup
Other [field text box]
10) What's your favorite blush or bronzer for your face and cheeks?
[radio buttons]
Cheekers Blush
CoverGirl Bronzer
Tantastic Bronzer
Other [field text box]
11) Clue us in! What's your secret to a good complexion?
[radio buttons]
Getting plenty of rest
Laying off the greasy foods
Washing my face every morning and every night
Getting help from a dermatologist
12) A great smile is half the battle! What's your favorite way to get a bright, white smile?
[radio buttons]
Crest Whitestrips Classic
Crest Whitestrips Premium
Crest Whitestrips Premium Plus
Other [field text box]
13) Highlights can make —or break! —your look. What's your fave for hair highlighting?
[radio buttons]
Herbal Essences Bold 'n Brilliant HighLights in Cool Blonde
Herbal Essences Bold 'n Brilliant HighLights in Rich Copper
Herbal Essences Bold 'n Brilliant HighLights in Golden Blonde
Other [field text box]
14) Don't like your hair color? Change it! What's your favorite hair color product?
[radio buttons]
Herbal Essences Bold 'n Brilliant Color in Star Light —Light Blonde
Herbal Essences Bold 'n Brilliant Color in Molten Lava —Auburn
Herbal Essences Bold 'n Brilliant Color in Bronze Ice —Medium Golden Brown
Other [field text box]
15) Speaking of which, should boys highlight or color their hair?
[radio buttons]
Eeeew! Never.
It depends on the guy.
Oh yeah! It's very cool.
16) Now it's your turn to clue US in on your beauty secret! Out of these products, what is
your absolute favorite? And (of course), WHY? [Field text box]

Vote! [Button; links to EX7.1.1 survey confirmation page if survey is complete. If question(s) are incomplete, page refreshes with error message and unanswered question(s) highlighted]

EX7.1: Current winners listing page

| | |
|---|---|
| Title: | Beinggirl Girl Picks!: My Beauty |
| Keywords: | None |
| Description: | Here are your faves! |

[Global Navigation]

The Scoop [links to ]
Your Period [links to ]
Ask Iris [links to ]
Express Yourself [links to ]

BG Girl Picks [links to EX7]

Past Winners [links to EX7.2]

Creative Expressions [links to ]
Laugh Out Loud [links to ]
Girl Talk [links to EX6 new Girl Talk landing page]
Submit Your Story [links to ]
FAQ [links to ]
bgAdvisor [links to ]

Fun Stuff [links to ]
The Goods [links to ]

[Sample text for comps can be mocked up from previous text as needed. Live text to come after first survey ends.]

EX7.1.1 survey confirmation page

| | |
|---|---|
| Title: | BG Girl Picks: My Beauty |
| Keywords: | None |
| Description: | Thanks for cluing us in! |

[Note: no navigation shows because page is displayed in new popup window after survey is completed]

| | |
|---|---|
| [Header] | Thanks for cluing us in! |
| [Content] | Now we've got to count up your faves and add them to those |
| | of teen girls from around the world. Check back to see which |
| | P&G products you've honored with a BG Girl Pick, and the |
| | trends you've helped define! |

EX7.2: future page for survey results archive

| | |
|---|---|
| Title: | BG Girl Picks!: Past results |
| Keywords: | None |
| Description: | Past Girl Pick winners |

[Global Navigation]

The Scoop [links to ]
Your Period [links to ]
Ask Iris [links to ]
Express Yourself [links to ]

BG Girl Picks [links to EX7]

Current Winners [links to EX7.1]
Past Winners [HIGHLIGHTED]

Creative Expressions [links to ]
Laugh Out Loud [links to ]
Girl Talk [links to EX6 new Girl Talk landing page]
Submit Your Story [links to ]
FAQ [links to ]
bgAdvisor [links to ]

Fun Stuff [links to ]
The Goods [links to ]

[Future content: as surveys are completed and new results posted, previous survey results to reside on this page]

Once the user checks back, the user can see the category winner, including what others in her peer group chose in response to choices in the survey questions. At this time the user, being informed of peer responses can be impressed upon to make purchase decisions based on validation by the peer choices. Such a suggestion provided by the survey results can drive purchase intent.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

I claim:

1. A method of facilitating purchasing decisions, the method comprising:
a. providing a survey such as an online questionnaire comprising a plurality of questions;
b. providing as choices in said survey a limited set of products from one manufacturer to be surveyed among a predetermined set of consumer peers;
c. urging users to complete said questions by selecting among choices of said products;
d. facilitating submission of said survey;
e. receiving said survey results; and
f. suggesting purchase decisions based on validation by said peers of said product choices.

2. The method of claim 1, wherein said survey is provided via the internet.

3. The method of claim 1, wherein said predetermined set of consumer peers comprises teenage girls.
